(19) United States
(12) Patent Application Publication
(10) Pub. No.: US 2023/0205345 A1
(43) Pub. Date: Jun. 29, 2023

(54) DISPLAY DEVICE AND WATCH

(71) Applicant: Japan Display Inc., Tokyo (JP)

(72) Inventors: Akihiko FUJISAWA, Tokyo (JP); Kaoru ITO, Tokyo (JP); Daichi ABE, Tokyo (JP)

(21) Appl. No.: 18/118,309

(22) Filed: Mar. 7, 2023

Related U.S. Application Data
(63) Continuation of application No. PCT/JP2021/032141, filed on Sep. 1, 2021.

(30) Foreign Application Priority Data
Sep. 9, 2020 (JP) 2020-151398

(51) Int. Cl. G06F 3/041; G04G 21/08; G06F 3/044

(52) U.S. Cl. CPC G06F 3/0412; G04G 21/08; G06F 3/0416; G06F 3/044

(57) ABSTRACT

According to one embodiment, a display device includes a first substrate, a second substrate, a display area, at least one first sensor electrode, a second sensor electrode and a detection circuit. The second substrate is opposed to the first substrate. The display area displays an image. The first sensor electrode is disposed in a peripheral area surrounding the display area. The second sensor electrode is disposed at a position overlapping the first sensor electrode in planar view. The detection circuit is electrically connected to the first sensor electrode. The second sensor electrode is set to a state of being electrically connected to nothing or a state of being biased by resistance of 50 kΩ or greater. The second sensor electrode is larger in area than the first sensor electrode.

### CROSS-REFERENCE TO RELATED APPLICATIONS

This application is a Continuation Application of PCT Application No. PCT/JP2021/032141, filed Sep. 1, 2021, and based upon and claiming the benefit of priority from Japanese Patent Application No. 2020-151398, filed Sep. 9, 2020, the entire contents of all of which are incorporated herein by reference.

### FIELD

Embodiments described herein relate generally to a display device and a watch.

### BACKGROUND

In recent years, wearable devices with a touch detection function (for example, wristwatch-type wearable devices and glasses-type wearable devices) have been gradually prevailing. Such wearable devices are required to achieve both display quality when an image is displayed and excellent operability by touch, and have been developed in various ways.

### BRIEF DESCRIPTION OF THE DRAWINGS

FIG. 1 is a plan view showing a structural example of a display device according to an embodiment.

FIG. 2 is a plan view showing another structural example of the display device according to the embodiment.

FIG. 3 is a plan view showing still another structural example of the display device according to the embodiment.

FIG. 4 is a plan view showing still another structural example of the display device according to the embodiment.

FIG. 5 is a cross-sectional view showing a schematic structural example of the display device according to the embodiment.

FIG. 6 is another cross-sectional view showing a schematic structural example of the display device according to the embodiment.

FIG. 7 is a cross-sectional view showing a schematic structural example of a display device according to a comparative example.

FIG. 8 is a cross-sectional view showing a schematic structural example of the display device according to a first modified example.

FIG. 9 is a cross-sectional view showing a schematic structural example of the display device according to a second modified example.

FIG. 10 is a cross-sectional view showing a schematic structural example of the display device according to a third modified example.

FIG. 11 is a cross-sectional view showing a schematic structural example of the display device according to a fourth modified example.

FIG. 12 is a cross-sectional view showing a schematic structural example of the display device according to a fifth modified example.

FIG. 13 is a cross-sectional view showing a schematic structural example of the display device according to a sixth modified example.

FIG. 14 is a cross-sectional view showing a schematic structural example of the display device according to a seventh modified example.

FIG. 15 is a cross-sectional view showing a schematic structural example of the display device according to an eighth modified example.

FIG. 16 is a plan view showing an example of a circuit connected to second detection electrodes of the display device according to the embodiment.

FIG. 17A is a plan view showing an example of another circuit connected to the second detection electrodes of the display device according to the embodiment.

FIG. 17B is a plan view showing an example of another circuit connected to the second detection electrodes of the display device according to the embodiment.

FIG. 18 is a plan view showing another structural example of the display device according to the embodiment.

FIG. 19 is a diagram for explaining a further modified example of the display device of the seventh modified example.

FIG. 20 is a diagram showing an application example of the display device according to the embodiment.

FIG. 21 is a diagram showing another application example of the display device according to the embodiment.

FIG. 22 is a diagram for explaining an example of the principle of self-capacitive touch detection.

### DETAILED DESCRIPTION

In general, according to one embodiment, a display device includes a first substrate, a second substrate, a display area, at least one first sensor electrode, a second sensor electrode and a detection circuit. The second substrate is opposed to the first substrate. The display area displays an image. The first sensor electrode is disposed in a peripheral area surrounding the display area. The second sensor electrode is disposed at a position overlapping the first sensor electrode in planar view. The detection circuit is electrically connected to the first sensor electrode. The second sensor electrode is set to a state of being electrically connected to nothing or a state of being biased by resistance of 50 kΩ or greater. The second sensor electrode is larger in area than the first sensor electrode.

According to another embodiment, a watch includes the above-described display device.

Embodiments will be described hereinafter with reference to the accompanying drawings.

The disclosure is merely an example, and proper changes within the spirit of the invention, which are easily conceivable by a skilled person, are included in the scope of the invention as a matter of course. In addition, in some cases, in order to make the description clearer, the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

In the present embodiment, a display device with a touch detection function will be described as an example of a display device. The types of touch detection include various types such as an optical type, a resistive type, a capacitive type, and an electromagnetic induction type. The capacitive type of the above-described detection types is a detection type which uses a change in capacitance caused by the approach or contact of an object (for example, a finger), and has the advantages of being feasible with a relatively simple structure and consuming low power, etc. The present embodiment mainly describes a display device with a capacitive touch detection function.

The capacitive type includes a mutual-capacitive type which generates an electric field between a transmission electrode (drive electrode) and a reception electrode (detection electrode) spaced apart from each other and detects a change in the electric field due to the approach or contact of an object, and a self-capacitive type which detects a change in capacitance due to the approach or contact of an object, using a single electrode. The present embodiment mainly describes a display device with a self-capacitive touch detection function.

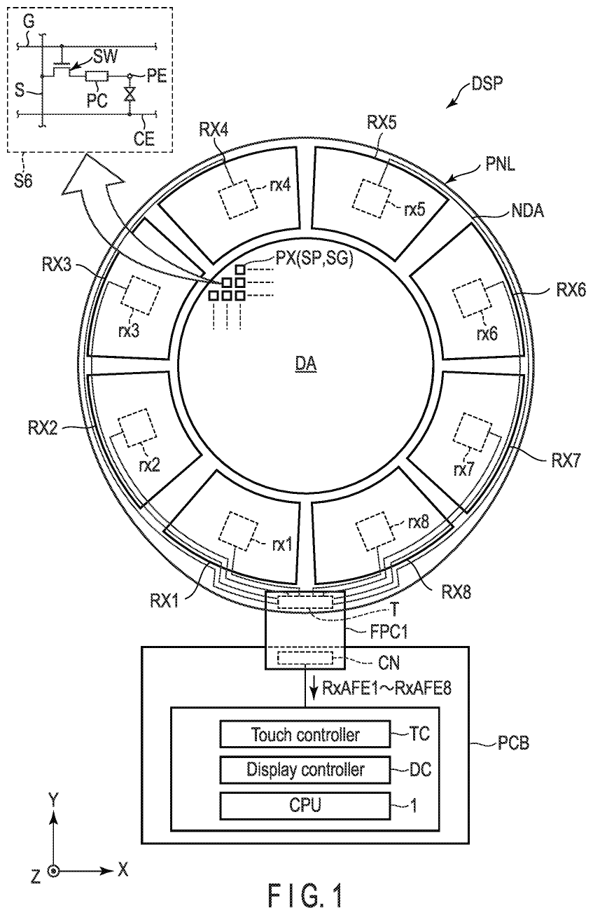

FIG. 1 is a plan view showing a structural example of a display device DSP of the present embodiment. For example, a first direction X, a second direction Y, and a third direction Z are orthogonal to each other but may intersect at an angle other than 90 degrees. The first direction X and the second direction Y correspond to directions parallel to a main surface of a substrate constituting the display device DSP, and the third direction Z corresponds to the thickness direction of the display device DSP. In the present specification, the direction toward the tip of an arrow indicating the third direction Z is also referred to as an upward direction, and the opposite direction from the tip of the arrow is also referred to as a downward direction. In addition, it is assumed that an observation position from which the display device DSP is observed is located on the tip side of the arrow indicating the third direction Z, and viewing from the observation position toward an X-Y plane defined by the first direction X and the second direction Y is referred to as planar view.

As shown in FIG. 1, the display device DSP comprises a display panel PNL, a flexible printed board FPC1, and a circuit board PCB. The display panel PNL and the circuit board PCB are electrically connected via the flexible printed board FPC1. More specifically, a terminal portion T of the display panel PNL and a connection portion CN of the circuit board PCB are electrically connected via the flexible printed board FPC1.

The display panel PNL comprises a display area DA which displays an image and a non-display area NDA in the form of a frame surrounding the display area DA. The display area DA is also referred to as a display portion. In addition, the non-display area NDA is also referred to as a peripheral portion or a peripheral area. In the display area DA, pixels PX are disposed. To be specific, in the display area DA, a large number of the pixels PX are arrayed in a matrix in the first direction X and the second direction Y. In the present embodiment, the pixels PX include red (R), green (G), and blue (B) subpixels SP. In addition, each of the subpixels SP includes segment pixels SG. The segment pixels SG comprise pixel electrodes having different areas, and the gradation of each subpixel SP is formed by switching the display and the non-display of the segment pixels SG.

The inner circular area of the concentric circles shown in FIG. 1 corresponds to the display area DA, and the area excluding the inner circle from the outer circle corresponds to the non-display area NDA. The present embodiment illustrates a case where the display area DA has a circular shape and the non-display area NDA surrounding the display area DA also has a similar shape. However, the present embodiment is not limited to this case. The display area DA may not have a circular shape and the non-display area NDA may have a shape different from that of the display area DA. For example, the display area DA and the non-display area NDA may have polygonal shapes. Moreover, if the display area DA has a polygonal shape, the non-display area NDA may have a circular shape, which is different from the shape of the display area DA.

As shown in FIG. 1, in the non-display area NDA, first detection electrodes (first sensor electrodes) rx1 to rx8 and second detection electrodes (second sensor electrodes) RX1 to RX8 are disposed to surround the display area DA. Each of the second detection electrodes RX1 to RX8 is disposed to overlap the corresponding one of the first detection electrodes rx1 to rx8 in planar view. That is, each of the second detection electrodes RX1 to RX8 is opposed to the corresponding one of the first detection electrodes rx1 to rx8, and the first detection electrodes rx and the second detection electrodes RX opposed to each other are capacitively coupled to each other. The respective areas of the second detection electrodes RX1 to RX8 are larger than the areas of the first detection electrodes rx1 to rx8, which they overlap in planar view.

FIG. 1 illustrates the eight first detection electrodes rx1 to rx8 and the eight second detection electrodes RX1 to RX8 corresponding thereto. However, the numbers of first detection electrodes rx and second detection electrodes RX disposed in the non-display area NDA are not limited to this example, and a freely selected number of first detection electrodes rx and a freely selected number of second detection electrodes RX may be disposed to surround the display area DA. Note that the number of first detection electrodes rx and the number of second detection electrodes RX are equal. The first detection electrodes rx1 to rx8 and the second detection electrodes RX1 to RX8 are each electrically connected to a wiring layer LL, which will be described later, via a conductive material not shown in the figure (conductive beads coated with metal). The wiring layer LL includes a terminal portion (pad), an rx line extending from the terminal portion toward the terminal portion T, etc. The rx line may be referred as to a wiring line. The rx line is a line used to supply a drive signal to the first detection electrodes rx1 to rx8 and output detection signals rxAFE1 to rxAFE8 from the first detection electrodes rx1 to rx8.

As shown in an enlarged manner in FIG. 1, the segment pixels SG each comprise a switching element SW, a pixel circuit PC, a pixel electrode PE, a common electrode CE, a liquid crystal layer LC, etc. The switching element SW is composed of, for example, a thin-film transistor (TFT), and is electrically connected to a scanning line G and a signal line S. The scanning line G is electrically connected to the respective switching elements SW in the segment pixels SG arranged in the first direction X. The signal line S is electrically connected to the respective switching elements SW in the segment pixels SG arranged in the second direction Y. The pixel electrodes PE are electrically connected to the switching elements SW via the pixel circuits PC. Each of the pixel electrodes PE is opposed to the common electrode CE, and drives the liquid crystal layer LC by an electric field generated between the pixel electrodes PE and the common electrode CE.

As shown in FIG. 1, a touch controller TC, a display controller DC, a CPU 1, etc., are disposed on the circuit board PCB. The touch controller TC outputs a drive signal to the first detection electrodes rx1 to rx8 disposed on the display panel PNL, and receives input of a detection signal (rxAFE signal) from the first detection electrodes rx1 to rx8 (that is, detects the approach or contact of an external approaching object). The touch controller TC may be referred to as a detection circuit. The display controller DC outputs a video signal indicating an image displayed in the display area DA of the display panel PNL. The CPU 1 performs output of a synchronization signal which defines the operation timing of the touch controller TC and the display controller DC, execution of an operation according to a touch detected by the touch controller TC, etc.

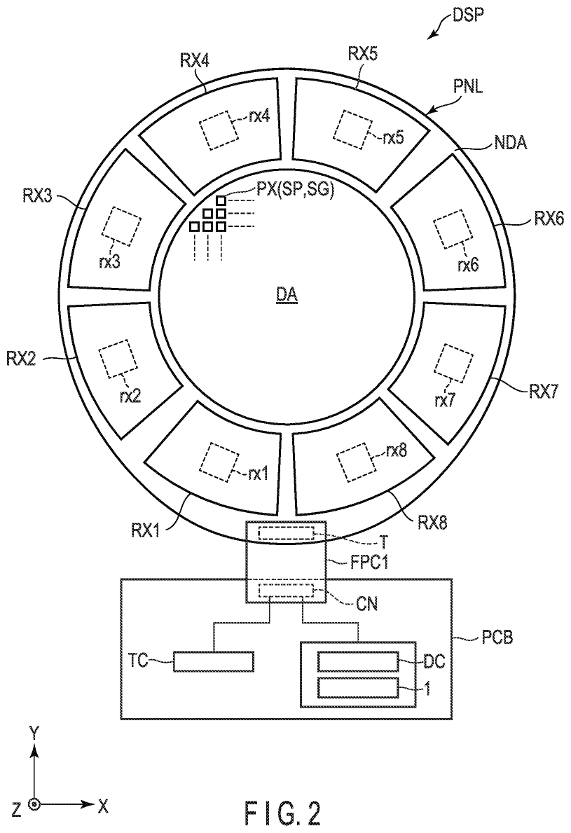

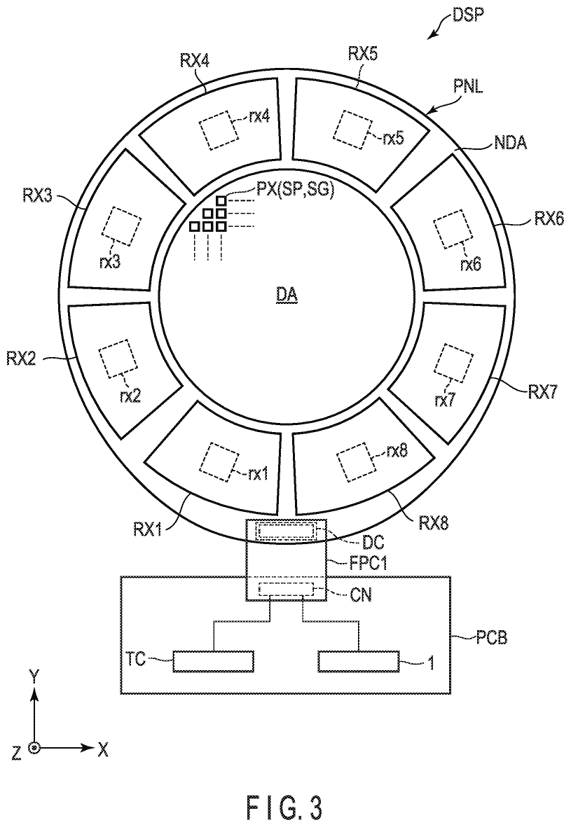

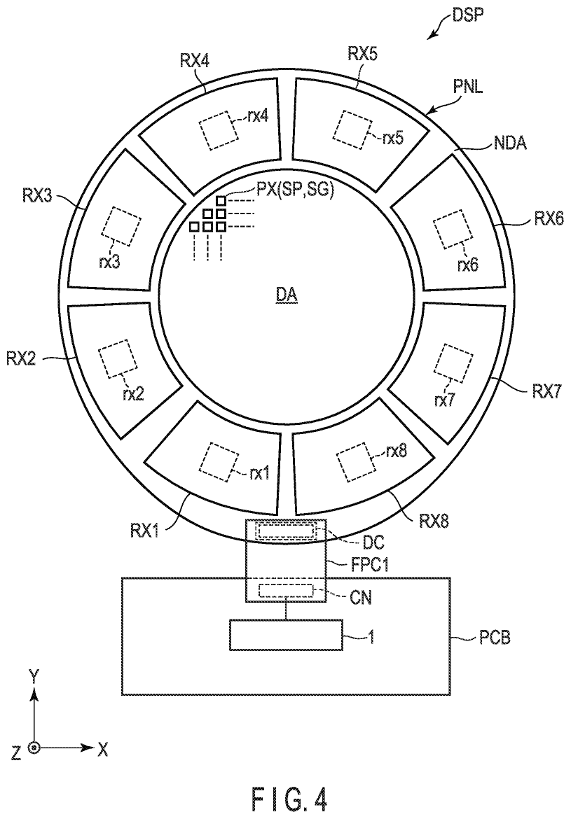

FIG. 1 illustrates a case where the touch controller TC, the display controller DC, and the CPU 1 are realized as a single semiconductor chip. However, their mounted form is not limited to this case. For example, as shown in FIG. 2, they may be mounted on the circuit board PCB while only the touch controller TC is separated from the others as a separate body. As shown in FIG. 3, the touch controller TC and the CPU 1 may be mounted separately on the circuit board PCB while the display controller DC is mounted on the display panel PNL by chip-on-glass (COG). As shown in FIG. 4, only the CPU 1 may be mounted on the circuit board PCB while the touch controller TC and the display controller DC are mounted on the display panel PNL by COG.

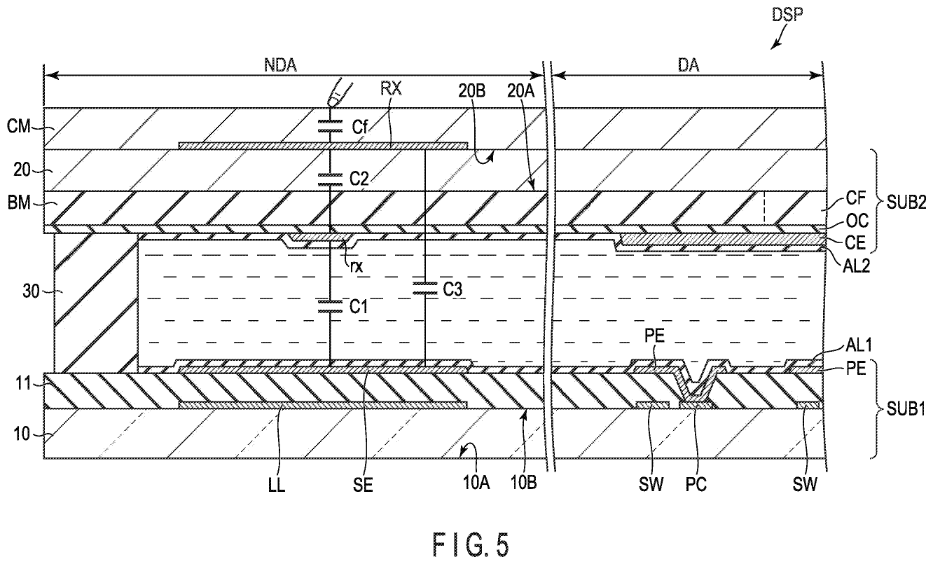

FIG. 5 is a cross-sectional view showing a schematic structural example of the display device DSP according to the present embodiment. In the following description, the structure on the display area DA side and the structure on the non-display area NDA will be each explained.

The display device DSP comprises a first substrate SUB1, a second substrate SUB2, a sealant 30, the liquid crystal layer LC, and a cover member CM. The first substrate SUB1 and the second substrate SUB2 are formed in the shape of flat plates parallel to the X-Y plane. The first substrate SUB1 and the second substrate SUB2 overlap in planar view, and are bonded together by the sealant 30. The liquid crystal layer LC is held between the first substrate SUB1 and the second substrate SUB2 and is sealed by the sealant 30. The sealant 30 includes a conductive material not shown in the figure, which electrically connects the structure on the first substrate SUB1 side and the structure on the second substrate SUB2 side to each other.

FIG. 5 illustrates a case where the display device DSP is a reflective display device in which a backlight unit is not disposed. However, the display device DSP is not limited to this case, and the display device DSP may be a display device in which organic EL is adopted as pixels or a transmissive display device in which a backlight unit is disposed. Alternatively, the display device DSP may be a display device of a combination of a reflective type and a transmissive type. As a backlight unit, various forms of backlight unit can be used. For example, a backlight unit with a light-emitting diode (LED) used as a light source, a backlight unit with a cold-cathode tube (CCFL) used as a light source, etc., can be used.

On the display area DA side, the first substrate SUB1 comprises a transparent substrate 10, the switching elements SW, the pixel circuits PC, a planarization film 11, the pixel electrodes PE, and an alignment film AL1 as shown in FIG. 5. In addition to the above-described structure, the first substrate SUB1 comprises the scanning line G and the signal line S shown in FIG. 1, etc., which are omitted from the illustration of FIG. 5.

The transparent substrate 10 comprises a main surface (lower surface) 10A and a main surface (upper surface) 10B opposite to the main surface 10A. The switching elements SW and the pixel circuits PC are disposed on the main surface 10B side. The planarization film 11 is composed of at least one or more insulating films, and covers the switching elements SW and the pixel circuits PC. The pixel electrodes PE are disposed on the planarization film 11, and are connected to the pixel circuits PC via contact holes formed in the planarization film 11. A switching element SW, a pixel circuit PC, and a pixel electrode PE are disposed for each segment pixel SG. The alignment film AL1 covers the pixel electrodes PE and contacts the liquid crystal layer LC.

In the illustration of FIG. 5, the switching elements SW and the pixel circuits PC are simplified. However, in reality, the switching elements SW and the pixel circuits PC include electrodes of a semiconductor layer and each layer. In addition, although omitted from the illustration of FIG. 5, the switching elements SW and the pixel circuits PC are electrically connected to each other. Moreover, as described above, the scanning line G and the signal line S, which are omitted from the illustration of FIG. 5, are disposed, for example, between the transparent substrate 10 and the planarization film 11.

On the display area DA side, the second substrate SUB2 comprises a transparent substrate 20, a color filter CF, an overcoat layer OC, the common electrode CE, and an alignment film AL2 as shown in FIG. 5.

The transparent substrate 20 comprises a main surface (lower surface) 20A and a main surface (upper surface) 20B opposite to the main surface 20A. The main surface 20A of the transparent substrate 20 is opposed to the main surface 10B of the transparent substrate 10. The color filter CF is disposed on the main surface 20A side of the transparent substrate 20. The color filter CF includes a red color filter, a green color filter, a blue color filter, etc. The overcoat layer OC covers the color filter CF. The common electrode CE is disposed over the segment pixels SG (pixels PX), and is opposed to the pixel electrodes PE in the third direction Z. The common electrode CE is disposed on the overcoat layer OC. The alignment film AL2 covers the common electrode CE and contacts the liquid crystal layer LC. In FIG. 5, the structure in which a light-shielding film which segments the segment pixels SG is not provided has been explained as the structure of the second substrate SUB2 on the display area DA side. However, a light-shielding film may be provided to segment the segment pixels SG and overlap part of the color filter CF.

The liquid crystal layer LC is disposed between the main surface 10A and the main surface 20A.

The transparent substrates 10 and 20 are insulating substrates, for example, glass base materials or plastic substrates. The planarization film 11 is formed of a transparent insulating material, for example, silicon oxide, silicon nitride, silicon oxynitride, or acrylic resin. For example, the planarization film 11 includes an inorganic insulating film and an organic insulating film. The pixel electrodes PE are formed as reflecting electrodes, and have, for example, a three-layer structure of indium zinc oxide (IZO), silver (Ag), and indium zinc oxide (IZO). The common electrode CE is a transparent electrode formed of a transparent conductive material, for example, indium tin oxide (ITO) or indium zinc oxide (IZO). The alignment films AL1 and AL2 are horizontal alignment films having alignment restriction force substantially parallel to the X-Y plane. The alignment restriction force may be imparted by rubbing treatment or may be imparted by optical alignment treatment.

On the non-display area NDA side, the first substrate SUB1 comprises the transparent substrate 10, the wiring layer LL, the planarization film 11, a shield electrode SE, and the alignment film AL1 as shown in FIG. 5. In the following description, a detail explanation of the structure that has been already described on the display area DA side is omitted.

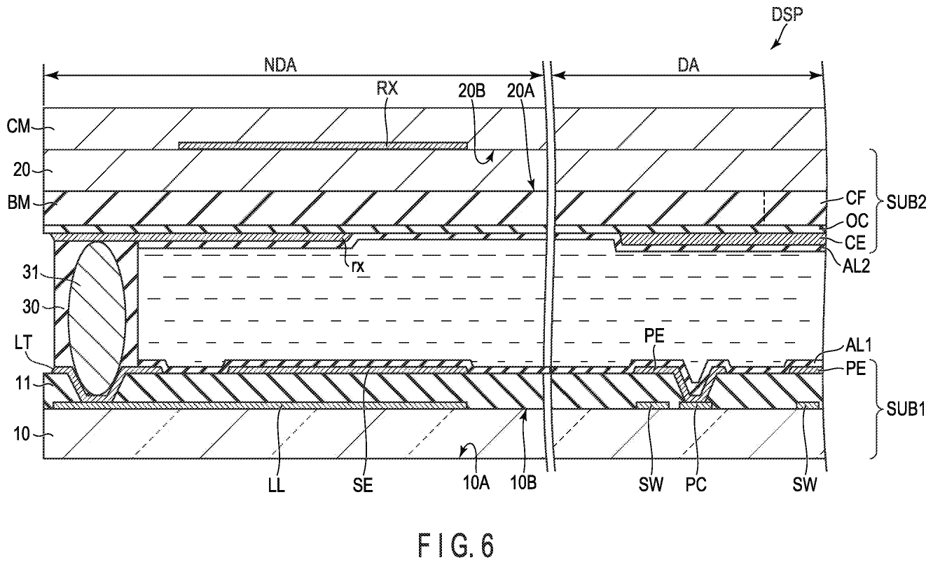

The wiring layer LL is disposed on the transparent substrate 10. For the sake of convenience, the wiring layer LL is simplified in the illustration of FIG. 5. However, as described above, the wiring layer LL includes the terminal portion (pad) and the rx line, which extends from the terminal portion toward the terminal portion T and is a detection line connected between the first detection electrodes rx and the detection circuit, and is electrically connected to the structure disposed on the second substrate SUB2 side (mainly the first detection electrodes rx) by a conductive material 31 included in the sealant 30 in the cross-section of FIG. 6, which is a cross-section different from that of FIG. 5. FIG. 6 shows a situation where a line terminal portion LT on the first substrate SUB1 side and the first detection electrodes rx on the second substrate SUB2 are electrically connected to each other by the conductive material 31 included in the sealant 30. FIG. 6 shows a situation where the wiring layer LL and the line terminal portion LT are connected to each other through a contact hole formed in the planarization film 11, whereby the first detection electrodes rx and the wiring layer LL including the rx line, etc., are electrically connected to each other.

The shield electrode SE is disposed on the planarization film 11 and is covered by the alignment film AL1. The shield electrode SE is disposed to prevent the wiring layer LL from being capacitively coupled to another structure (mainly the first detection electrodes rx and the second detection electrodes RX). A direct voltage of a predetermined value is applied to the shield electrode SE.

On the non-display area NDA side, the second substrate SUB2 comprises the transparent substrate 20, a light-shielding film BM, the overcoat layer OC, the first detection electrodes rx, the alignment film AL2, and the second detection electrodes RX as shown in FIG. 5. In the following description, a detail explanation of the structure that has been already described on the display area DA side is omitted.

The light-shielding film BM is disposed on the main surface 20A side of the transparent substrate 20. The light-shielding film BM is disposed over substantially all the non-display area NDA. The overcoat layer OC, together with the color filter CF on the display area DA side, covers the light-shielding film BM. The first detection electrodes rx are disposed on the overcoat layer OC. In the structure shown in FIG. 5, the first detection electrodes rx are disposed in the same layer as the common electrode CE on the display area DA side, and are formed of, for example, the same transparent conductive material as that of the common electrode CE. The alignment film AL2 covers the first detection electrodes rx and contacts the liquid crystal layer LC.

The second detection electrodes RX are disposed on the main surface 20B side of the transparent substrate 20. The second detection electrodes RX are opposed to the first detection electrodes rx. The second detection electrodes RX are formed to be larger in area than the first detection electrodes rx. The second detection electrodes RX are set to a state of being electrically connected to nothing (floating state or high impedance state) or a state of being biased by resistance of a predetermined value or greater (for example, 50 kΩ or greater).

FIG. 5 illustrates the structure in which the second detection electrodes RX overlap the first detection electrodes rx, the shield electrode SE, and the wiring layer LL in planar view. Note that, the second detection electrodes RX may not overlap the shield electrode SE and the wiring layer LL in planar view. In addition, FIG. 5 illustrates the structure in which the first detection electrodes rx overlap the second detection electrodes RX, the shield electrode SE and the wiring layer LL in planar view. Note that, the first detection electrodes rx may not overlap the shield electrode SE and the wiring layer LL in planar view. In terms of touch detection, the first detection electrodes rx preferably should not overlap the shield electrode SE and the wiring layer LL in planar view, which will be described later in detail.

FIG. 5 illustrates the structure in a case where the liquid crystal mode, which is classified into two modes according to the application direction of an electric field for changing the alignment of liquid crystal molecules included in the liquid crystal layer LC, is the so-called vertical electric field mode. However, this structure is also applicable to a case where the liquid crystal mode is the so-called horizontal electric field mode. The above-described vertical electric field mode includes, for example, a twisted nematic (TN) mode and a vertical alignment (VA) mode. In addition, the above-described horizontal electric field mode includes, for example, an in-plane switching (IPS) mode and a fringe field switching (FFS) mode, which is one of the in-plane switching (IPS) modes. When the horizontal electric field mode is adopted, the common electrode CE provided in the display area is provided on the first substrate SUB1 side and is opposed to the pixel electrodes PE with a thin insulating layer interposed therebetween.

A comparative example is herein given to explain advantages of the display device DSP of the present embodiment. The comparative example is intended to explain part of the advantages that can be achieved by the display device DSP of the present embodiment, and does not exclude advantages common to the comparative example and the present embodiment from the scope of the present invention.

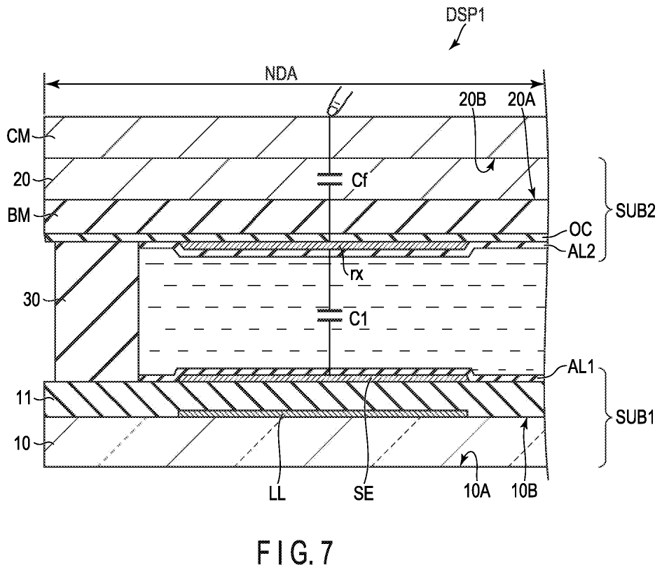

FIG. 7 is a cross-sectional view showing a schematic structural example of a display device DSP1 according to the comparative example. Because the structure on the display area DA side of the display device DSP1 of the comparative example is the same as that of the display device DSP of the present embodiment, the structure on the display area DA side is omitted from the illustration of FIG. 7. The display device DSP1 of the comparative example is different from the display device DSP of the present embodiment in that the second detection electrodes RX in a state of being electrically connected to nothing (floating state or high impedance state) or a state of being biased by resistance of a predetermined value or greater is not provided in a layer higher than the first detection electrodes rx. The display device DSP1 of the comparative example is different from the display device DSP of the present embodiment in that the areas of the first detection electrodes rx are larger than the areas of the first detection electrodes rx in the present embodiment and are equivalent to the areas of the second detection electrodes RX in the present embodiment.

In the display device DSP1 of the comparative example, when the cover member CM is touched by a finger (that is, when an external approaching object approaches or contacts the cover member CM), the detection electrodes rx read a change in capacitance Cf formed between the cover member CM and the finger, and detects the touch. However, in the display device DSP1 of the comparative example, the areas of the first detection electrodes rx are made larger to expand the range where a touch can be detected (touch detection range). Thus, capacitance C1 formed between the first detection electrodes rx and the shield electrode SE in a lower layer also increases. The above-described capacitance Cf is extremely small as compared to the capacitance C1 (that is, the capacitance Cf<the capacitance C1). Thus, when the capacitance C1 is too large, it may exceed the dynamic range of the detection circuit. In this case, even when the cover member CM is touched, the touch may not be detected. Thus, the touch detection accuracy may decline.

In contrast, in the display device DSP of the present embodiment, since the areas of the first detection electrodes rx are made smaller (that is, the areas of the first detection electrodes rx of the present embodiment are smaller than the areas of the first detection electrodes rx of the comparative example), the capacitance C1 formed between the first detection electrodes rx and the shield electrode SE can be reduced, as compared to that in the above-described comparative example. If the areas of the first detection electrodes rx are merely made smaller than the comparative example shown in FIG. 7 (that is, the areas of the first detection electrodes rx of the present embodiment are smaller than the areas of the first detection electrodes rx of the comparative example), the touch detection range becomes narrower. However, in the display device DSP of the present embodiment, the second detection electrodes RX, which are capacitively coupled to the first detection electrodes rx and which are larger in area than the first detection electrodes rx, are provided in a layer higher than the first detection electrodes rx (in other words, between the first detection electrodes rx and a finger). In this case, when the cover member CM is touched by a finger, the first detection electrodes rx read a change in the combined capacitance of capacitance C2 formed between the first detection electrodes rx and the second detection electrodes RX and the capacitance Cf between the second detection electrodes RX and the finger, and detects the touch. That is, not the area where the first detection electrodes rx are disposed, but the area where the second detection electrodes RX are disposed can be used as the touch detection range. Accordingly, it is possible to prevent the narrowing of the touch detection range by the second detection electrodes RX, while reducing the capacitance C1 by making the areas of the first detection electrodes rx smaller than the comparative example shown in FIG. 7 (that is, the areas of the first detection electrodes rx of the present embodiment are smaller than the areas of the first detection electrodes rx of the comparative example). That is, it is possible to reduce the above-described decline of the touch detection accuracy while securing the touch detection range.

Note that, as already described above, the second detection electrodes RX are set to a state of being electrically connected to nothing (floating state or high impedance state) or a state of being biased by resistance of a predetermined value or greater. Accordingly, the capacitance C2 formed between the first detection electrodes rx and the second detection electrodes RX can be reduced, and thus, the influence of the second detection electrodes RX on touch detection can be minimized. In addition, since the second detection electrodes RX are provided, capacitance C3 is also formed between the second detection electrodes RX and the shield electrode SE. However, as described above, since the second detection electrodes RX are set to a state of being electrically connected to nothing or a state of being biased by resistance of a predetermined value or greater, the capacitance C3 also can be reduced as in the case of the capacitance C2, and its influence on touch detection can be minimized. The capacitance C1, the capacitance C2, and the capacitance C3 in the display device DSP have the following relation: C1>C2>C3.

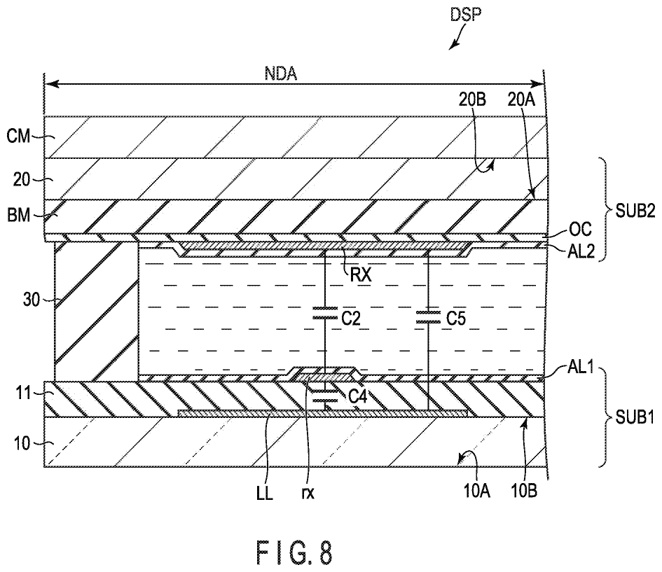

In the following description, modified examples of the display device DSP of the present embodiment will be explained with reference to FIG. 8 to FIG. 15. Because the structure on the display area DA side is the same as the structure shown in FIG. 5, the structure on the display area DA side is omitted from the illustrations of FIG. 8 to FIG. 15.

### FIRST MODIFIED EXAMPLE

FIG. 8 is a cross-sectional view showing a schematic structural example of the display device DSP according to a first modified example. The display device DSP of the first modified example is different from the structure shown in FIG. 5 in that the first detection electrodes rx are provided on, not the second substrate SUB2 side, but the first substrate SUB1 side. The display device DSP of the first modified example is different from the structure shown in FIG. 5 in that the second detection electrodes RX are provided on, not the main surface 20B side, but the main surface 20A side of the transparent substrate 20. In other words, the display device DSP of the first modified example is different from the structure shown in FIG. 5 in that the first detection electrodes rx are provided in the same layer as the pixel electrodes PE and the second detection electrodes RX are provided in the same layer as the common electrode CE. The display device DSP of the first modified example is different from the structure shown in FIG. 5 also in that the shield electrode SE is not provided.

Also in this case, the areas of the first detection electrodes rx are small as compared to those in the comparative example shown in FIG. 7 (that is, the areas of the first detection electrodes rx in this case are smaller than the areas of the first detection electrodes rx of the comparative example). Thus, capacitance C4 formed between the first detection electrodes rx and the wiring layer LL, which may influence touch detection, can be reduced. In addition, the second detection electrodes RX, which are capacitively coupled to the first detection electrodes rx and which are larger in area than the first detection electrodes rx, are provided in a layer higher than the first detection electrodes rx. Thus, it is also possible to prevent the narrowing of the touch detection range. That is, the same advantages as those of the above-described structure shown in FIG. 5 can be achieved.

Note that, as already described above, the second detection electrodes RX are set to a state of being electrically connected to nothing (floating state or high impedance state) or a state of being biased by resistance of a predetermined value or greater. Accordingly, the capacitance C2 formed between the first detection electrodes rx and the second detection electrodes RX can be reduced, and thus, the influence of the second detection electrodes RX on touch detection can be minimized. In addition, since the second detection electrodes RX are provided, capacitance C5 is also formed between the second detection electrodes RX and the wiring layer LL. However, as described above, the second detection electrodes RX are set to a state of being electrically connected to nothing or a state of being biased by resistance of a predetermined value or greater. Thus, the capacitance C5 also can be reduced as in the case of the capacitance C2, and its influence on touch detection can be minimized. The capacitance C2, the capacitance C4, and the capacitance C5 in the display device DSP have the following relations: C4>C2>C5.

### SECOND MODIFIED EXAMPLE

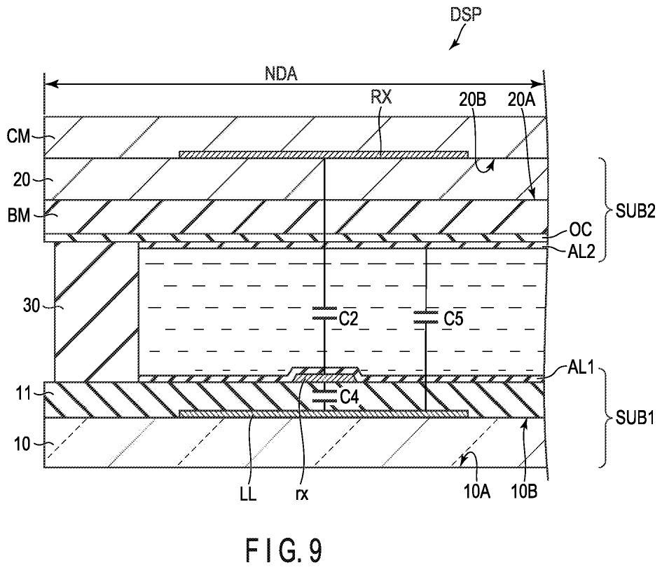

FIG. 9 is a cross-sectional view showing a schematic structural example of the display device DSP according to a second modified example. The display device DSP of the second modified example is different from the structure shown in FIG. 5 in that the first detection electrodes rx are provided in the same layer as the pixel electrodes PE. The display device DSP of the second modified example is different from the structure shown in FIG. 5 also in that the shield electrode SE is not provided.

Also in this case, the areas of the first detection electrodes rx are small as compared to those in the comparative example shown in FIG. 7 (that is, the areas of the first detection electrodes rx in this case are smaller than the areas of the first detection electrodes rx of the comparative example). Thus, the above-described capacitance C4, which may influence touch detection, can be reduced. In addition, the second detection electrodes RX, which are capacitively coupled to the first detection electrodes rx and which are larger in area than the first detection electrodes rx, are provided in a layer higher than the first detection electrodes rx. Thus, it is also possible to prevent the narrowing of the touch detection range. That is, the same advantages as those of the above-described structure shown in FIG. 5 can be achieved.

### THIRD MODIFIED EXAMPLE

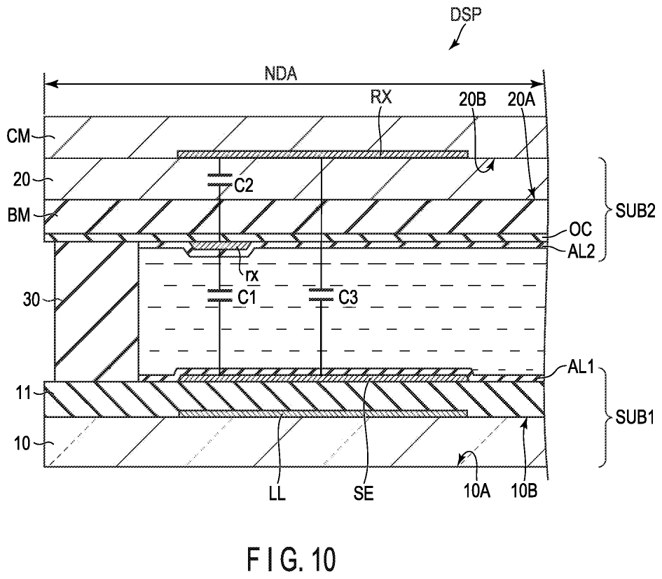

FIG. 10 is a cross-sectional view showing a schematic structural example of the display device DSP according to a third modified example. The display device DSP of the third modified example is different from the structure shown in FIG. 5 in that the first detection electrodes rx are disposed, not near the centers of the second detection electrodes RX, but at positions near ends of the second detection electrodes RX than the centers of the second detection electrodes RX (that is, positions away from the display area DA). FIG. 10 illustrates a case where the first detection electrodes rx are disposed at positions away from the display area DA. Note that, the first detection electrodes rx may be disposed at positions near the display area DA than the center of the second detection electrodes RX.

Also in this case, the areas of the first detection electrodes rx are small as compared to those in the comparative example shown in FIG. 7 (that is, the areas of the first detection electrodes rx in this case are smaller than the areas of the first detection electrodes rx of the comparative example). Thus, the above-described capacitance C1, which may influence touch detection, can be reduced. In addition, the second detection electrodes RX, which are capacitively coupled to the first detection electrodes rx and which are larger in area than the first detection electrodes rx, are provided in a layer higher than the first detection electrodes rx. Thus, it is also possible to prevent the narrowing of the touch detection range. That is, the same advantages as those of the above-described structure shown in FIG. 5 can be achieved.

### FOURTH MODIFIED EXAMPLE

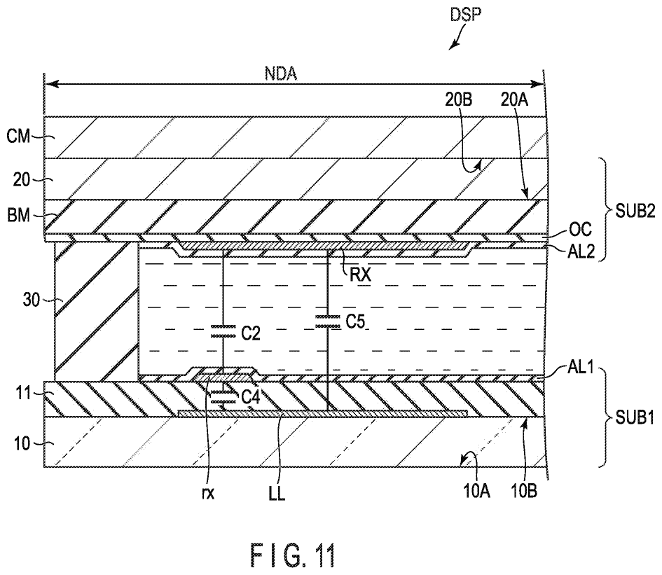

FIG. 11 is a cross-sectional view showing a schematic structural example of the display device DSP according to a fourth modified example. The display device DSP of the fourth modified example is different from the structure shown in FIG. 8 in that the first detection electrodes rx are disposed, not near the centers of the second detection electrodes RX, but positions near ends of the second detection electrodes RX than the centers of the second detection electrodes RX (that is, positions away from the display area DA). FIG. 11 illustrates a case where the first detection electrodes rx are disposed at positions away from the display area DA. Note that, the first detection electrodes rx may be disposed at positions near the display area DA than the center of the second detection electrodes RX.

Also in this case, the areas of the first detection electrodes rx are small as compared to those in the comparative example shown in FIG. 7 (that is, the areas of the first detection electrodes rx in this case are smaller than the areas of the first detection electrodes rx of the comparative example). Thus, the above-described capacitance C4, which may influence touch detection, can be reduced. In addition, the second detection electrodes RX, which are capacitively coupled to the first detection electrodes rx and which are larger in area than the first detection electrodes rx, are provided in a layer higher than the first detection electrodes rx. Thus, it is also possible to prevent the narrowing of the touch detection range. That is, the same advantages as those of the above-described structure shown in FIG. 8 (that is, the same advantages as those of the structure shown in FIG. 5) can be achieved.

### FIFTH MODIFIED EXAMPLE

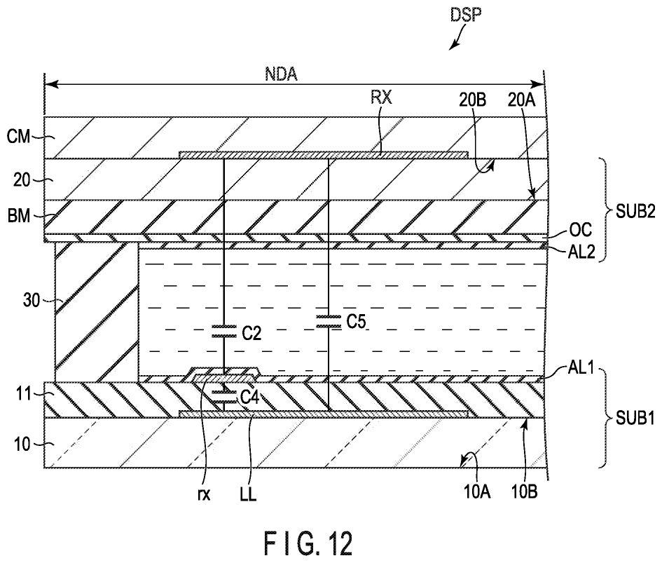

FIG. 12 is a cross-sectional view showing a schematic structural example of the display device DSP according to a fifth modified example. The display device DSP of the fifth modified example is different from the structure shown in FIG. 9 in that the first detection electrodes rx are disposed, not near the centers of the second detection electrodes RX, but at positions near ends of the second detection electrodes RX than the centers of the second detection electrodes RX (that is, positions away from the display area DA). FIG. 12 illustrates a case where the first detection electrodes rx are disposed at positions away from the display area DA. Note that, the first detection electrodes rx may be disposed at positions near the display area DA than the center of the second detection electrodes RX.

Also in this case, the areas of the first detection electrodes rx are small as compared to those in the comparative example shown in FIG. 7 (that is, the areas of the first detection electrodes rx in this case are smaller than the areas of the first detection electrodes rx of the comparative example). Thus, the above-described capacitance C4, which may influence touch detection, can be reduced. In addition, the second detection electrodes RX, which are capacitively coupled to the first detection electrodes rx and which are larger in area than the first detection electrodes rx, are provided in a layer higher than the first detection electrodes rx. Thus, it is also possible to prevent the narrowing of the touch detection range. That is, the same advantages as those of the above-described structure shown in FIG. 9 (that is, the same advantages as those of the structure shown in FIG. 5) can be achieved.

### SIXTH MODIFIED EXAMPLE

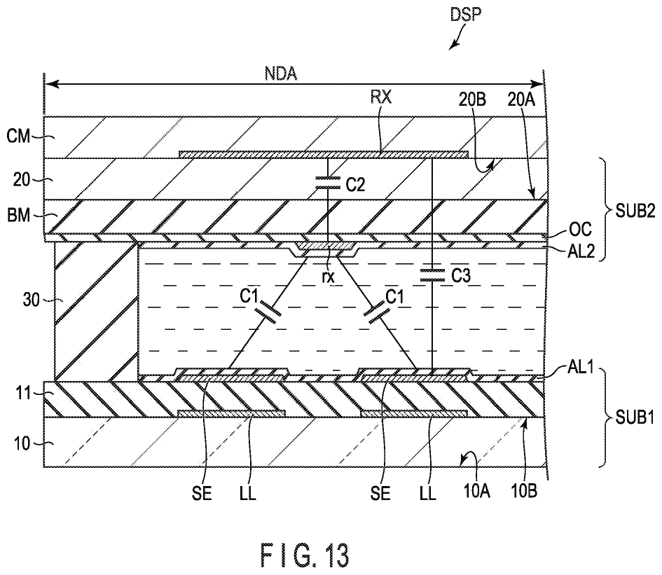

FIG. 13 is a cross-sectional view showing a schematic structural example of the display device DSP according to a sixth modified example. The display device DSP of the sixth modified example is different from the structure shown in FIG. 5 in that the shield electrode SE and the wiring layer LL are not provided directly under the first detection electrodes rx.

Also in this case, the areas of the first detection electrodes rx are small as compared to those in the comparative example shown in FIG. 7 (that is, the areas of the first detection electrodes rx in this case are smaller than the areas of the first detection electrodes rx of the comparative example). Thus, the above-described capacitance C1, which may influence touch detection, can be reduced. In the display device DSP of the sixth modified example, since the shield electrode SE (and the wiring layer LL) is not provided directly under the first detection electrodes rx, the capacitance C1 formed between the first detection electrodes rx and the shield electrode SE can be reduced more than in the structure shown in FIG. 5.

In the display device DSP of the sixth modified example, too, the second detection electrodes RX, which are capacitively coupled to the first detection electrodes rx and which are larger in area than the first detection electrodes rx, are provided in a layer higher than the first detection electrodes rx. Thus, it is also possible to prevent the narrowing of the touch detection range.

The display device DSP of the above-described sixth modified example can achieve the same advantages as those of the above-described structure shown in FIG. 5, or can further reduce the decline of the touch detection accuracy because the capacitance C1 can be reduced more than in the structure of FIG. 5 as described above.

### SEVENTH MODIFIED EXAMPLE

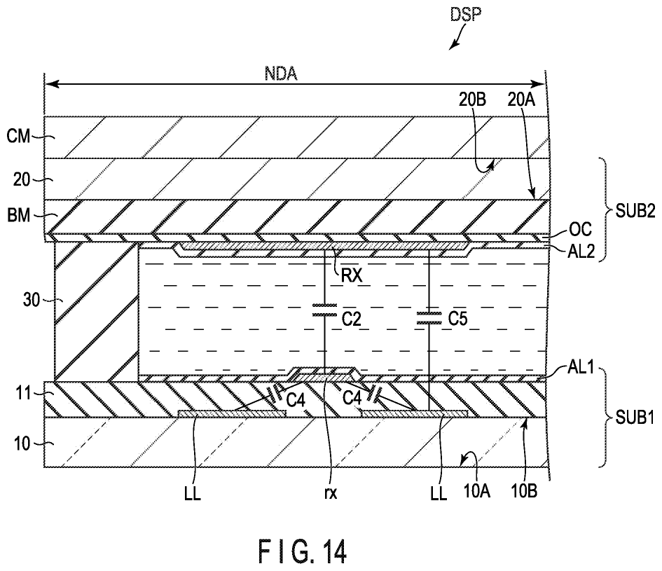

FIG. 14 is a cross-sectional view showing a schematic structural example of the display device DSP according to a seventh modified example. The display device DSP of the seventh modified example is different from the structure shown in FIG. 8 in that the wiring layer LL is not provided directly under the first detection electrodes rx.

Also in this case, the areas of the first detection electrodes rx are small as compared to those in the comparative example shown in FIG. 7 (that is, the areas of the first detection electrodes rx in this case are smaller than the areas of the first detection electrodes rx of the comparative example). Thus, the above-described capacitance C4, which may influence touch detection, can be reduced. In the display device DSP of the seventh modified example, since the wiring layer LL is not provided directly under the first detection electrodes rx, the capacitance C4 formed between the first detection electrodes rx and the wiring layer LL can be reduced more than in the structure shown in FIG. 8.

In the display device DSP of the seventh modified example, too, the second detection electrodes RX, which are capacitively coupled to the first detection electrodes rx and which are larger in area than the first detection electrodes rx, are provided in a layer higher than the first detection electrodes rx. Thus, it is also possible to prevent the narrowing of the touch detection range.

The display device DSP of the above-described seventh modified example can achieve the same advantages as those of the above-described structure shown in FIG. 8, or can further reduce the decline of the touch detection accuracy because the capacitance C4 can be reduced more than in the structure of FIG. 8 as described above.

### EIGHTH MODIFIED EXAMPLE

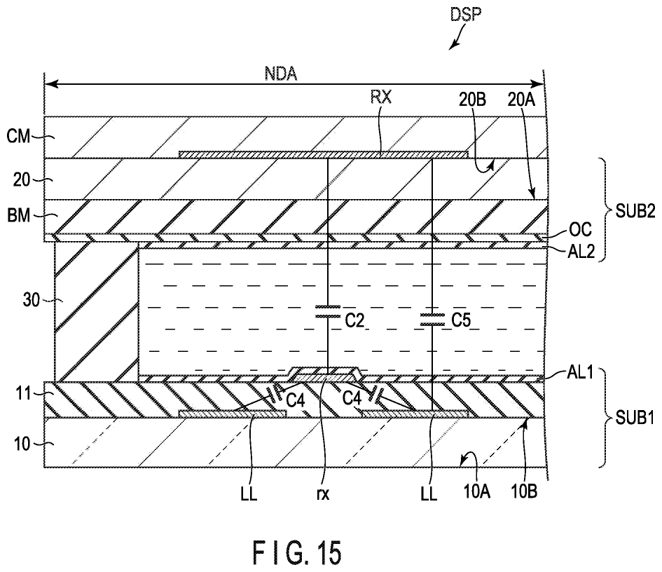

FIG. 15 is a cross-sectional view showing a schematic structural example of the display device DSP according to an eighth modified example. The display device DSP of the eighth modified example is different from the structure shown in FIG. 9 in that the wiring layer LL is not provided directly under the first detection electrodes rx.

Also in this case, the areas of the first detection electrodes rx are small as compared to those in the comparative example shown in FIG. 7 (that is, the areas of the first detection electrodes rx in this case are smaller than the areas of the first detection electrodes rx of the comparative example). Thus, the above-described capacitance C4, which may influence touch detection, can be reduced. In the display device DSP of the eighth modified example, since the wiring layer LL is not provided directly under the first detection electrodes rx, the capacitance C4 formed between the first detection electrodes rx and the wiring layer LL can be reduced more than in the structure shown in FIG. 9.

In the display device DSP of the eighth modified example, too, the second detection electrodes RX, which are capacitively coupled to the first detection electrodes rx and which are larger in area than the first detection electrodes rx, are provided in a layer higher than the first detection electrodes rx. Thus, it is also possible to prevent the narrowing of the touch detection range.

The display device DSP of the above-described eighth modified example can achieve the same advantages as those of the above-described structure shown in FIG. 9 or can further reduce the decline of the touch detection accuracy because the capacitance C4 can be reduced more than in the structure of FIG. 9 as described above.

The display device DSP of the present embodiment repeatedly executes operations in a touch detection period for detecting a touch by the first detection electrodes rx1 to rx8 and the second detection electrodes RX1 to RX8 disposed in the non-display area NDA and in a display period for displaying an image in the display area DA. During the touch detection period, the touch controller TC of the display device DSP supplies a drive signal to each of the first detection electrodes rx1 to rx8, and receives input of the detection signals rxAFE1 to rxAFE8 from the first detection electrodes rx1 to rx8 in response to the drive signal. The touch controller TC thereby detects whether the touch detection ranges defined by the second detection electrodes RX1 to RX8, respectively, have been touched and which touch detection range has been touched. In contrast, during the display period, the display controller DC of the display device DSP outputs a video signal indicating an image displayed in the display area DA.

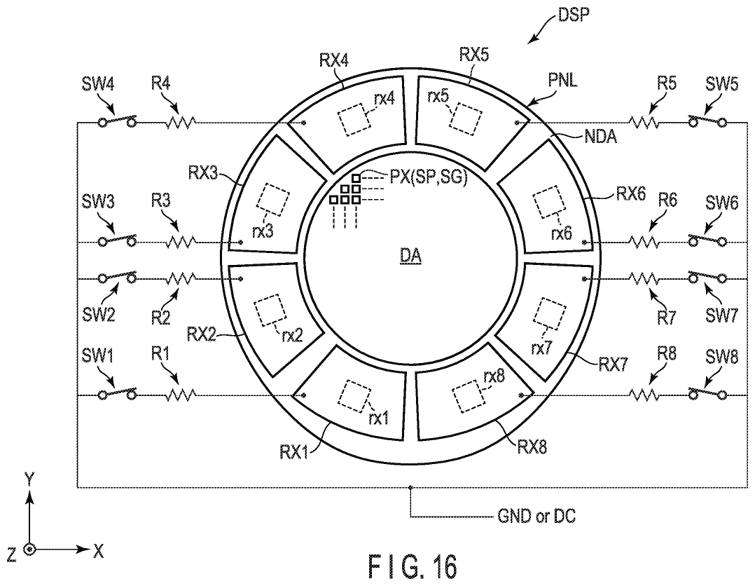

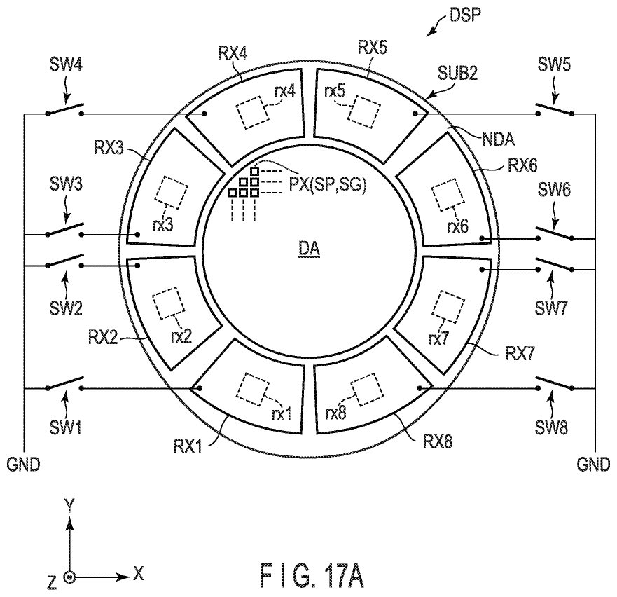

During the touch detection period, to detect a touch (define the touch detection ranges), the second detection electrodes RX1 to RX8 are set to a state of being electrically connected to nothing (floating state or high impedance state) or a state of being biased by resistance of a predetermined value or greater. For example, as shown in FIG. 16, the second detection electrodes RX1 to RX8 can be set to a state of being biased by resistance of a predetermined value or greater by applying a ground voltage or a predetermined direct voltage to the second detection electrodes RX1 to RX8 via resistors R1 to R8 having resistance of a predetermined value or greater (for example, 50 kΩ or greater). Alternatively, as shown in FIG. 17A, the second detection electrodes RX1 to RX8 can be set to a state of being electrically connected to nothing by opening switches SW1 to SW8 connected to the second detection electrodes RX1 to RX8, respectively. The second detection electrodes RX1 to RX8 also may be set to a state of being electrically connected to nothing by opening the switches SW1 to SW8 shown in FIG. 16.

During the display period, the second detection electrodes RX1 to RX8 are set to a ground potential. For example, as shown in FIG. 17B, the second detection electrodes RX1 to RX8 can be set to the ground potential by closing the switches SW1 to SW8 connected to the second detection electrodes RX1 to RX8, respectively, and applying a ground voltage to the second detection electrodes RX1 to RX8. By setting the second detection electrodes RX1 to RX8 to the ground potential, it is possible to prevent the second detection electrodes RX1 to RX8 from interfering with the display area DA during the display period, and to reduce the decline of the display quality of an image displayed in the display area DA. In addition, by setting the second detection electrodes RX1 to RX8 to the ground potential, the potential just before the touch detection period can be determined. Thus, it is also possible to reduce the variation of detection capacitance of each sensing (that is, further reduce the decline of the touch detection accuracy).

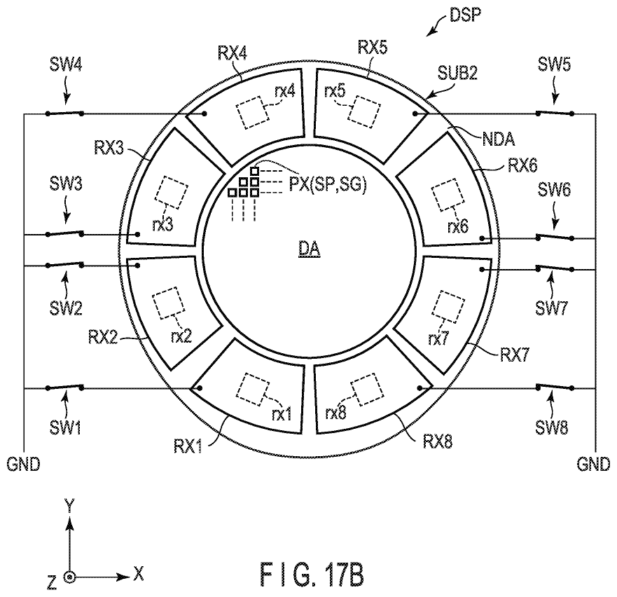

The above-described present embodiment illustrates the structure in which nothing is disposed between adjacent two second detection electrodes RX of the second detection electrodes RX1 to RX8 of the display device DSP as shown in FIG. 1. However, for example, as shown in FIG. 18, shield electrodes SE1 to SE8 to which a predetermined direct voltage is applied (in other words, the shield electrodes SE1 to SE8 to which a predetermined direct voltage is applied and whose potentials are fixed) may be disposed between adjacent two second detection electrodes RX. Accordingly, the shield electrodes SE disposed between adjacent two second detection electrodes RX can prevent the adjacent two second detection electrodes RX from being capacitively coupled to each other, and can further reduce the decline of the touch detection accuracy.

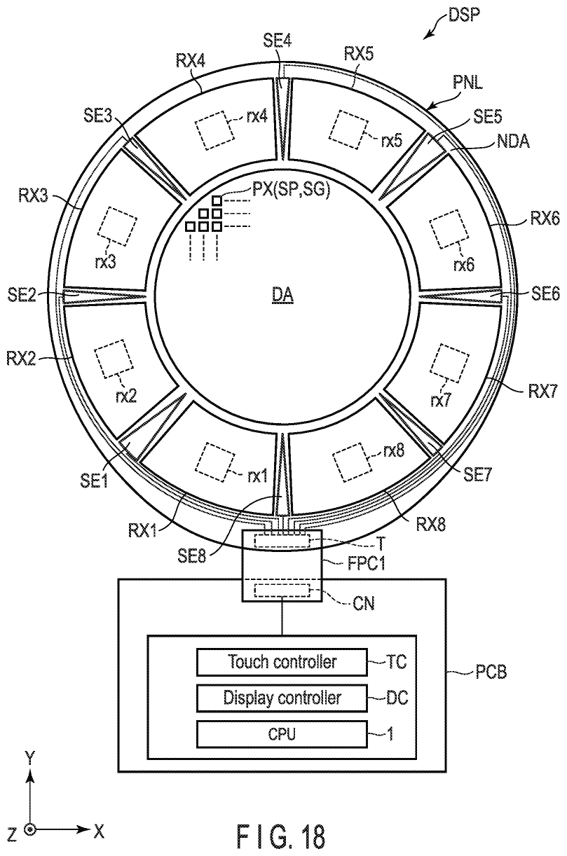

FIG. 19 is a diagram for explaining a further modified example of the display device DSP of the above-described seventh modified example. Part (a) of FIG. 19 is a plan view showing part of the display device DSP of the present modified example, and part (b) of FIG. 19 is a cross-sectional view showing a cross section along line A-B shown in part (a) of FIG. 19.

As shown in an enlarged manner in part (a) of FIG. 19, the second detection electrodes RX overlap the wiring layer LL and the first detection electrodes rx in planar view. In addition, the wiring layer LL and the first detection electrodes rx do not overlap in planer view, and the wiring layer LL is disposed at a position nearer the display area DA, and the first detection electrodes rx are disposed at positions farther away from the display area DA. Thus, when cut along line A-B shown in part (a) of FIG. 19, the second detection electrodes RX overlap the wiring layer LL and the first detection electrodes rx in planar view as shown in part (b) of FIG. 19. In addition, as shown in part (b) of FIG. 19, the wiring layer LL is not provided directly under the first detection electrodes rx.

Also in this case, the areas of the first detection electrodes rx are small as compared to those in the already described comparative example in FIG. 7 (that is, the areas of the first detection electrodes rx in this case are smaller than the areas of the first detection electrodes rx of the comparative example). Thus, the above-described capacitance C4, which may influence touch detection, can be reduced. In the display device DSP shown in part (b) of FIG. 19, since the wiring layer LL is not provided directly under the first detection electrodes rx, the capacitance C4 formed between the first detection electrodes rx and the wiring layer LL can be reduced to the same degree as in the structure shown in FIG. 14.

In the display device DSP of the present modified example, too, the second detection electrodes RX, which are capacitively coupled to the first detection electrodes rx and which are larger in area than the first detection electrodes rx, are provided in a layer higher than the first detection electrodes rx. Thus, it is also possible to prevent the narrowing of the touch detection range.

The display device DSP having the structure shown in FIG. 19 can achieve the same advantages as those of the structure shown in FIG. 14.

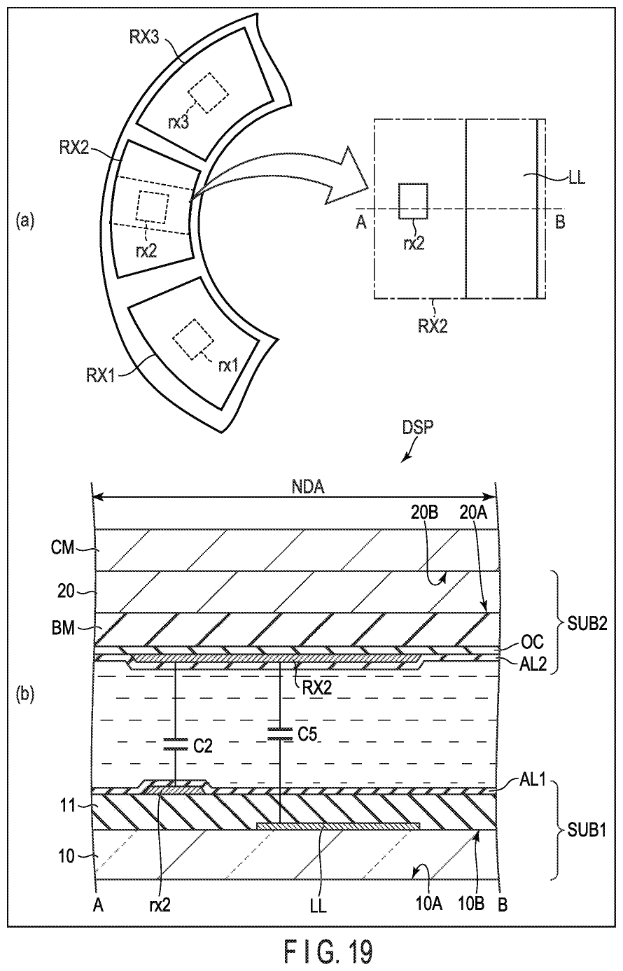

FIG. 20 shows an application example of the display device DSP according to the present embodiment. As shown in FIG. 20, the display device DSP is applied to, for example, a wristwatch 100. In this case, the display area DA of the display device DSP displays time, etc., and the display device DSP can detect a predetermined gesture made by touching a detection electrode disposed in the non-display area NDA (for example, a gesture made by touching the outer circumferential portion of the watch to make one clockwise rotation, a gesture made by touching the outer circumferential portion of the watch to make one counterclockwise rotation, or a tap gesture), and execute an operation according to the detected predetermined gesture.

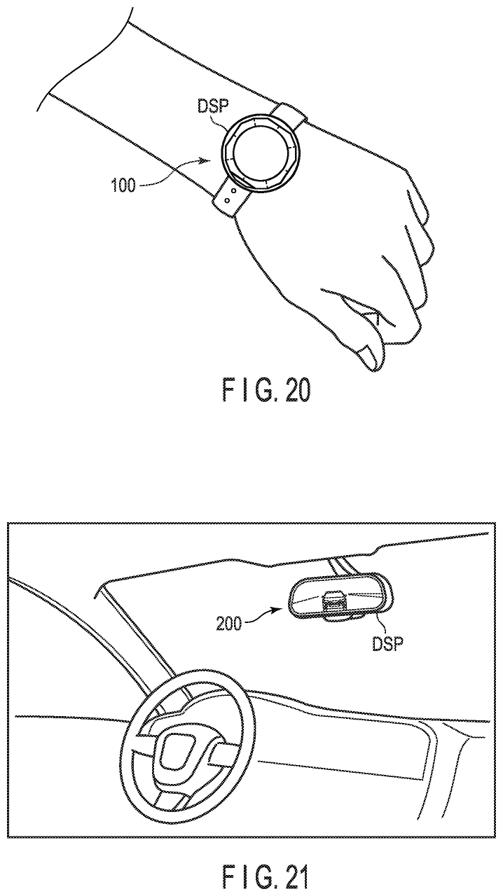

FIG. 21 shows another application example of the display device DSP of the present embodiment. As shown in FIG. 21, the display device DSP is applied to, for example, an in-vehicle rear-view mirror 200. In this case, the display area DA of the display device DSP displays video of an area behind a vehicle shot by a camera installed in the vehicle, etc., and the display device DSP can detect a predetermined gesture made by touching a detection electrode disposed in the non-display area NDA and execute an operation according to the detected predetermined gesture.

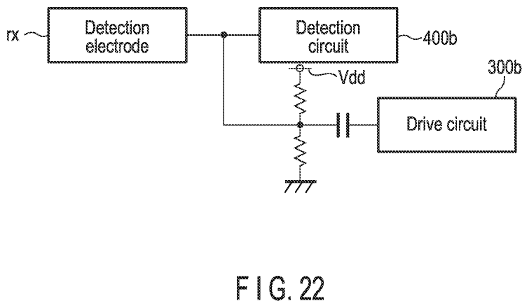

FIG. 22 is a diagram for explaining an example of the principle of self-capacitive touch detection. A voltage obtained by dividing the voltage of a power supply Vdd by voltage divider using resistor is applied to a detection electrode rx as a bias voltage. From a drive circuit 300b, a drive signal of a predetermined waveform is supplied to the detection electrode rx through capacitive coupling, etc., and a detection signal of a predetermined waveform is read from the detection electrode rx. At this time, when capacitance by a finger, etc., is added to the detection electrode rx, the amplitude of the detection electrode rx changes. In FIG. 22, the amplitude of the detection electrode rx declines. Accordingly, in an equivalent circuit illustrated in FIG. 22, the amplitude of the detection electrode rx is detected by a detection circuit 400b, and it is thereby detected whether or not an external approaching object such as a finger contacts or approaches. A self-detection circuit is not limited to the circuit illustrated in FIG. 22. As long as the presence or absence of an external approaching object such as a finger can be detected by only a detection electrode, any circuit systems may be adopted.

According to the above-described one embodiment, the display device DSP comprises the first detection electrodes rx, which are electrically connected to the touch controller TC, and the second detection electrodes RX, which overlap the first detection electrodes rx in planar view, which are disposed in a layer higher than the first detection electrodes rx, and which are larger in area than the first detection electrodes rx. Accordingly, since the areas of the first detection electrodes rx can be made smaller than the comparative example shown in FIG. 7 (that is, the areas of the first detection electrodes rx of the present embodiment can be made smaller than the areas of the first detection electrodes rx of the comparative example), it is possible to reduce the capacitance which is formed between the first detection electrodes rx and other structures opposed thereto (for examples, the shield electrode SE and the wiring layer LL) and which may influence touch detection. In addition, since the second detection electrodes RX are disposed in a layer higher than the first detection electrodes rx, when the cover member CM is touched by a finger, the touch is detected on the basis of a change in the combined capacitance of the capacitance formed between the first detection electrodes rx and the second detection electrodes RX (capacitance C2) and the capacitance formed between the second detection electrodes RX and the finger (capacitance Cf). That is, not the area where the first detection electrodes rx are disposed, but the area where the second detection electrodes RX are disposed can be used as the touch detection range.

As described above, the present embodiment can prevent the narrowing of the touch detection range by the second detection electrodes RX, while reducing the capacitance which may influence touch detection by making the areas of the first detection electrodes rx smaller than the comparative example shown in FIG. 7 (that is, the areas of the first detection electrodes rx of the present embodiment are smaller than the areas of the first detection electrodes rx of the comparative example). That is, it is possible to reduce the decline of the touch detection accuracy while securing the touch detection range, and to provide a display device and a watch which achieve both display quality when an image is displayed and excellent operability by touch.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate;
a second substrate opposed to the first substrate;
a display area which displays an image;
at least one first sensor electrode disposed in a peripheral area surrounding the display area;
a second sensor electrode disposed at a position overlapping the first sensor electrode in planar view; and
a detection circuit electrically connected to the first sensor electrode,
the second sensor electrode being set to a state of being electrically connected to nothing or a state of being biased by resistance of 50 kΩ or greater,
the second sensor electrode being larger in area than the first sensor electrode.

2. The display device of claim 1, wherein
the first sensor electrode is disposed on the second substrate side.

3. The display device of claim 2, wherein
the first substrate comprises a pixel electrode,
the second substrate comprises a common electrode, and
the first sensor electrode is disposed in the same layer as the common electrode.

4. The display device of claim 1, wherein
the first substrate comprises a pixel electrode,
the second substrate comprises a common electrode, and
the first sensor electrode is disposed in the same layer as the pixel electrode.

5. The display device of claim 4, wherein
the second sensor electrode is disposed in the same layer as the common electrode.

6. The display device of claim 1, further comprising a wiring line included in a display-device internal circuit disposed at a position overlapping the second sensor electrode, wherein
the first sensor electrode does not overlap the wiring line included in the display-device internal circuit.

7. The display device of claim 1, wherein
a plurality of second sensor electrodes are disposed,
the display device further comprises a shield electrode disposed between adjacent two second sensor electrodes, and
the shield electrode is fixed at a first potential.

8. The display device of claim 1, wherein
the second sensor electrode is set to a state of being electrically connected to nothing or being biased by resistance of 50 kΩ or greater after a second potential is applied before detection starts.

9. The display device of claim 8, wherein
the second potential is a ground potential.

10. A watch comprising the display device of claim 1.
